(19) United States
(12) Patent Application Publication
(10) Pub. No.: US 2020/0031996 A1
(43) Pub. Date: Jan. 30, 2020

(54) POLYMERIZABLE COMPOSITION

(71) Applicant: LANXESS Deutschland GmbH, Cologne (DE)

(72) Inventors: Michael WITT, Eckersdorf (DE); Dominic FUCHS, Cologne (DE); Michaela FRANK, Leverkusen (DE); Dirk STEINHILBER, Neuss (DE)

(73) Assignee: LANXESS Deutschland GmbH, Cologne (DE)

(21) Appl. No.: 16/338,142

(22) PCT Filed: Sep. 26, 2017
(86) PCT No.: PCT/EP2017/074364

§ 371 Date: Mar. 29, 2019

(30) Foreign Application Priority Data
Oct. 7, 2016 (EP) 16192727.2

(51) Int. Cl. C08G 69/18; B01J 31/02; C08G 18/78

(52) U.S. Cl. CPC C08G 69/18; B01J 2231/127; C08G 18/7812; B01J 31/0245

(57) ABSTRACT

A polymerizable composition comprising
a) a cyclic amide formed from a mixture of laurolactam and caprolactam, where the amount of laurolactam is 10% to 35% by weight, based on the total amount of cyclic amide,
b) at least one activator, and
c) at least one catalyst for polymerization of the cyclic amides.

The present invention relates to a polymerizable composition comprising a specific mixture of caprolactam and laurolactam as cyclic amides, to the preparation thereof and to the use thereof for preparation of polyamide, especially a fiber-reinforced composite with a polyamide matrix, having the feature of only low volume shrinkage in the polymerization.

The anionic polymerization of lactams enables very rapid conversion of an activated lactam melt to a polyamide. Polyamides are part of the class of the thermoplastics and thus show different properties than other commercial encapsulating compounds based on epoxy resins, phenolic resins or polyurethane systems that lead either to thermosets or else to crosslinked polymers.

Thermoplastics can be recycled in a particularly simple manner at the end of the life-cycle of a component.

It is known that cast polyamides can be produced typically by blending a lactam together with at least one catalyst and at least one activator and polymerizing the caprolactam melt thus activated thereafter.

It is only the activator that allows polymerization temperature to be lowered to such an extent that the polymerization is of interest for industrial processes, and a fully polymerized polymer or composite body can be removed from the mold within a few minutes.

The literature describes the anionic polymerization both of caprolactam and of laurolactam for ambient-pressure production of thick-wall parts; see Sächtling Kunststoff Taschenbuch [Plastics Handbook], ISBN 978-3-446-43442-4, 31st edition, 2013, page 554.

If, however, in a departure from the conventional cast polymerization, polymerization is not effected in open molds and the casting produced by anionic lactam polymerization is not brought to the desired dimensions by mechanical reworking such as sawing and milling, the volume shrinkage that results in the course of conversion of the activated lactam melt to the polymer body constitutes a major problem. As well as different dimensions, polymerization in molds that close in a gas-tight manner often gives rise to bubbles in the polymer, which purely in visual terms give the impression of reduced product quality, but also distinctly lower mechanical properties, for example tensile strength and impact resistance.

In the 30th edition of the abovementioned Sächtling Kunststoff Taschenbuch (ISBN 978-3-446-40352-9), on page 538, the volume shrinkage of polyamides made from caprolactam or laurolactam is stated to be about 15% in each case. This disadvantage is particularly serious in the case of encapsulated components such as cables or engine parts, since there can easily be stresses or even cracks in the event of loads. Correspondingly, the use spectrum of a straight cast PA 6 or cast PA 12 polymerization is limited.

In the RIM PA 6 process with continuous fiber reinforcement as well, the volume shrinkage of the polymerizing lactam melt constitutes a challenge. For instance, in the case of polymerization in closed cavities, the result of volume shrinkage can be that the matrix is pulled back behind the fiber surface of the textile reinforcement inserted into the cavity beforehand, and hence visually low-quality components. In the case of an RIM PA 6 process, where RIM stands for “reactive injection molding”, a textile reinforcing fiber is first impregnated with the low-viscosity activated lactam melt and then the lactam is polymerized; a composite polymer component is formed directly or “in situ”. The basics of the RIM PA process are described by P. Wagner in Kunststoffe 73, 10 (1983), pages 588-590.

In the assessment of volume shrinkage, three effects in total should be noted, which is explained here using the example of the polymerization of caprolactam.

Caprolactam is generally used as flake material for cast and RIM polymerization.

For anionic polymerization, caprolactam, which is solid at room temperature, is brought to its melting temperature of 69° C. and then heated further to a polymerization temperature of about 150° C. The increase in temperature of the melt from 69 to 150° C. reduces the density of the melt.

Two effects in particular should be noted in the polymerization, both of which result in a volume contraction: polymerization and crystallization. The finished polymer forms directly at the polymerization temperature.

In the course of cooling to room temperature, the polymer will then increase further in density as a result of the polymer-characteristic coefficient of expansion.

In the literature, volume shrinkage is generally based on all three factors, i.e. on the shrinkage that the hot liquid lactam melt undergoes as a result of polymerization and crystallization and additionally on the reduction in volume induced by the cooling of the polymer to room temperature. Volume shrinkage is basically associated with a proportional increase in density and is determined as follows:

volume shrinkage in percent=(1−density of the polymerizable composition at 150° C./density of the polymer obtained therefrom at room temperature, 23° C.)×100.

For many applications, the first two factors in particular, volume reduction by polymerization and crystallization, are crucial for the later quality of the component.

If, for example, a cavity is filled with activated caprolactam melt at the polymerization temperature, then sealed gas-tight, the volume shrinkage caused by polymerization and crystallization results either in cavities or in finely divided gas bubbles that lead to a visually and mechanically low-quality component.

If the component is then demolded directly at the polymerization temperature and cooled only thereafter, there is a change in dimensions of the component and bubbles arise, but no longer in the course of cooling.

Statement of Object:

There was thus a need for a polymerizable composition for preparation of polyamide that can be polymerized to the later final outlines especially directly in the mold within a few minutes, which enables low residual monomer contents without additional measures and which shows distinctly lower volume shrinkage particularly in the course of polymerization and hence overcomes the disadvantages of the prior art.

Achievement of Object:

Surprisingly, a polymerizable composition has been found, comprising
a) a cyclic amide comprising a mixture of lauryllactam and caprolactam, where the amount of laurolactam is 10% to 35% by weight, especially 20% to 35% by weight, based on the total amount of cyclic amide,
b) at least one activator, and
c) at least one catalyst for anionic polymerization of the cyclic amides.

Volume shrinkage in the polymerization of the composition of the invention is distinctly reduced compared to pure caprolactam.

Component a)

Cyclic amides used here are a mixture comprising caprolactam and laurolactam, where the cyclic amides in the polymerizable composition of the invention consist, preferably to an extent of more than 95% by weight, especially to an extent of more than 98% by weight, of caprolactam and laurolactam. Mixtures of different lactams for adhesive applications are already known from DE3730504 C1.

Component b)

The activator of component b) preferably comprises those activators based on blocked aliphatic isocyanates, preferably diisocyanates, especially isophorone diisocyanate (IPDI) or preferably those of the formula OCN—(CH₂)₄₋₂₀—NCO, especially butylene diisocyanate, hexamethylene diisocyanate (HDI), octamethylene diisocyanate, decamethylene diisocyanate, undecamethylene diisocyanate or dodecamethylene diisocyanate. Particular preference is given to blocked hexamethylene diisocyanate (HDI).

A preferred blocking agent of the isocyanates of component b) is lactam, especially caprolactam-blocked diisocyanate. It is also possible here in principle to use differently blocked polyisocyanates in a mixture.

Particular preference is given to caprolactam-blocked HDI, N,N′-hexane-1,6-diylbis(hexahydro-2-oxo-1H-azepine-1-carboxamide), CAS No.: 5888-87-9.

The mass ratio of the cyclic amides of component a) to the blocked isocyanate of component b) may be varied within broad limits and is generally 1:1 to 10 000:1, preferably 5:1 to 2000:1, more preferably 20:1 to 1000:1.

Component c)

The catalyst c) for polymerization, especially anionic polymerization, of the cyclic amides is preferably at least one selected from the group consisting of sodium caprolactamate, potassium caprolactamate, magnesium bromide caprolactamate, magnesium chloride caprolactamate, magnesium bis(caprolactamate), sodium hydride, sodium, sodium hydroxide, sodium methoxide, sodium ethoxide, sodium propoxide, sodium butoxide, potassium hydride, potassium hydroxide, potassium methoxide, potassium ethoxide, potassium propoxide and potassium butoxide, preferably from the group consisting of sodium hydride, sodium and sodium caprolactamate, more preferably sodium caprolactamate.

The molar ratio of the cyclic amides a) to catalyst c) can be varied within broad limits. It is generally 1:1 to 10 000:1, preferably 5:1 to 1000:1, more preferably 1:1 to 500:1.

Preferably, the polymerizable composition of the invention contains 50% to 100% by weight of components a) to c), preferably 80% to 100% by weight, especially 90% to 100%, more preferably 95% to 100%, based on the total weight of the composition.

More preferably, the composition of the invention comprises an activator of component b) based on a caprolactam-blocked hexamethylene diisocyanate and, as a catalyst of component b), sodium caprolactamate.

Further Additions

The polymerizable composition of the invention may comprise one or more polymers, where the polymer may in principle be selected from polymers that are obtained in the polymerization of the composition polymerizable in accordance with the invention, and different polymers and polymer blends.

In a suitable embodiment, the polymerizable composition of the invention may also comprise filler. Fillers, especially particulate fillers, may have a wide range of particle sizes ranging from particles in dust form to coarse-grain particles. Useful filler material includes organic or inorganic fillers and/or fibrous materials. For example, it is possible to use inorganic fillers, such as kaolin, chalk, wollastonite, talc, calcium carbonate, silicates, titanium dioxide, zinc oxide, graphite, graphenes, glass particles, e.g. glass beads, nanoscale fillers such as carbon nanotubes, carbon black, nanoscale sheet silicates, nanoscale aluminum oxide (Al₂O₃) and nanoscale titanium dioxide (TiO₂). These fillers likewise reduce the volume shrinkage that results from the polymerization. By combination of the effect of the invention and the use of fillers, this shrinkage can be reduced further.

Preferably, fillers are used in an amount in the range from 0% to 90% by weight, especially in the range from 0% to 50% by weight, based on the polymerizable composition of the invention.

In addition, one or more fibrous substances may be used. These are preferably selected from known inorganic reinforcing fibers, such as boron fibers, glass fibers, carbon fibers, silica fibers, ceramic fibers and basalt fibers; organic reinforcing fibers, such as aramid fibers, polyester fibers, nylon fibers, polyethylene fibers; and natural fibers, such as wood fibers, flax fibers, hemp fibers and sisal fibers.

Especially preferred is the use of glass fibers, carbon fibers, aramid fibers, boron fibers or metal fibers. The fibers mentioned are preferably used in the form of continuous fibers, for example in the form of tapes, scrims, weaves or knits. It is also possible to use an unordered fiber collection, especially in the form of mats, nonwovens or else cut fibers of different fiber length, especially of 0.1 mm to several centimeters in length, preferably up to 5 cm in length.

However, these fiber materials are preferably used only in the application of the polymerizable composition of the invention for production of a fiber-reinforced composite which is likewise of the invention. In this case too, the shrinkage is further reduced by the fibers, based on the total volume.

In a preferred embodiment, the polymerizable composition of the invention may comprise one or more further additives. Additives added may, for example, be stabilizers, such as copper salts, dyes, antistats, separating agents, antioxidants, light stabilizers, PVC stabilizers, lubricants, separating agents, blowing agents, and combinations thereof. These additives are preferably in an amount of 0% to 5% by weight, preferably of 0% to 4% by weight, more preferably of 0% to 3.5% by weight, based on the total weight of the polymerizable composition. If flame retardants or impact modifiers are used as additives, these additives may be used from 0% to 45% by weight, based on the total weight of the polymerizable composition.

The polymerizable composition may comprise at least one additive, preferably in an amount of at least 0.01% by weight, based on the total weight of the polymerizable composition, more preferably of at least 0.1% by weight, based on the total weight of the polymerizable composition, especially of at least 0.5% by weight, based on the total weight of the polymerizable composition.

Preferably, the composition polymerizable in accordance with the invention comprises, as additive, at least one impact modifier. If the impact modifier used is a polymeric compound, it is counted among the aforementioned polymers. More particularly, the impact modifier used is a polydiene polymer (e.g. polybutadiene, polyisoprene). These preferably contain anhydride and/or epoxy groups. The polydiene polymer especially has a glass transition temperature below 0° C., preferably below −10° C., more preferably below −20 ° C. The polydiene polymer may be based on the basis of a polydiene copolymer with polyacrylates, polyethylene acrylates and/or polysiloxanes and be prepared by means of standard methods (e.g. emulsion polymerization, suspension polymerization, solution polymerization, gas phase polymerization).

Typical impact modifiers and cold impact modifiers are also based on functionalized polyether glycols, for example Addonyl® 8073 supplied by Rhein Chemie Rheinau GmbH, and on triamines, for example on polyoxypropylenetriamines, as supplied under the Addonyl® 8112 name by the same company.

Production of the Polymerizable Composition

The invention further relates to a process for preparing the polymerizable composition, characterized in that the mixture of the cyclic amides of component a) is contacted with at least one blocked polyisocyanate of component b) and at least one catalyst of component c).

Preferably, the polymerizable composition is provided by first mixing components b) and c) independently in a). Only at a later time, generally directly prior to the anionic polymerization, are these individual mixtures then mixed with one another. The process is therefore preferably characterized in that an activator mixture comprising cyclic amides of component a) and at least one activator of component b) is contacted with a catalyst mixture comprising cyclic amides of component a) and at least one catalyst of component c).

The mixing can be effected in solid form of the respective individual components a) and b) and of a) and c), or in liquid form.

For conversion of the liquid mixed phase of components a), b) and c), i.e. of the activated lactam melt, preference is given to choosing a temperature equal to or greater than the melting point of the resulting mixture, especially 70 to 160° C.

The components can be mixed batchwise or continuously. Suitable apparatuses for mixing of the components are known to those skilled in the art. For batchwise mixing, preference is given to using stirred tanks or kneaders. Continuous mixing operations are preferably effected within the extruder, and also by means of static mixing elements implemented in a mixing head or directly within the mold, or else by mixing by means of countercurrent injection. The mixing apparatus is preferably temperature-controllable.

Both the activator(s) and the catalyst(s) may also be used in the form of finished commercial products.

As possible activator of component b) there is caprolactam-blocked hexamethylene diisocyanate, for example commercially under the Brüggolen® C20 name from Brüggemann or Addonyl® 8120 from Rhein Chemie Rheinau GmbH.

A possible catalyst of component c) that may be used is a solution of sodium caprolactamate in caprolactam, e.g. Brüggolen© C10 from Brüggemann, containing 17% to 19% by weight of sodium caprolactamate in caprolactam, or Addonyl KAT NL from Rhein Chemie Rheinau GmbH, containing 18.5% by weight of sodium caprolactamate in caprolactam. Likewise suitable as catalyst c) is especially magnesium bromide caprolactamate, e.g. Brüggolen® C1 from Brüggemann.

The polymerizable composition is preferably transferred rapidly to a cavity intended for full polymerization.

In addition, it is possible to prepare what are called instant mixtures of components a) and b) and a) and c). These instant mixtures can then be combined in the desired ratio in order to use the polymerizable composition of the invention for preparation of polymers with low shrinkage.

The time required for the composition of the invention to solidify on attainment of polymerization temperature is preferably less than 10 minutes, more preferably less than 5 minutes, especially less than 1 minute.

Correspondingly, the polymerizable composition should be processed rapidly.

Particular preference is given to polymerizable compositions comprising
a) a catalyst melt containing a mixture of caprolactam, laurolactam and Addonyl Kat NL, and
b) an activator melt containing a mixture of caprolactam and laurolactam with N,N′-hexane-1,6-diylbis(hexahydro-2-oxo-1H-azepine-1-carboxamide,
   where Addonyl KAT NL represents an 18.5% by weight solution of sodium caprolactamate in caprolactam and the amount of laurolactam in the polymerizable compositions is 10% to 35% by weight based on the total amount of cyclic amide.

Production of a Polymer Matrix, Especially a Fiber Composite

The invention further relates to a process for producing a polymer matrix, characterized in that the polymerizable composition is treated at a temperature of 120 to 200° C., preferably at 120 to 180° C., especially at 140 to 160° C.

A cavity, for example containing the electrical, current-conducting components of a cable strand or of an electric motor, is encapsulated with the polymerizable composition of the invention and optionally fully polymerized by increasing the temperature.

The invention further relates to a process for producing a fiber composite material, characterized in that
i) the polymerizable composition of the invention or the individual components a), b) and c) thereof is contacted with fibers and
ii) the resulting composition is treated at a temperature of 120 to 200° C., preferably at 120 to 180° C., especially at 140 to 160° C.

The fibers may be contacted here with the polymerizable composition in various ways:
1) By inserting fibers, especially textile reinforcing structures, into a heated pressure-tight mold, preferably with a temperature of 120 to 200° C., and using elevated pressure to inject the polymerizable composition, preferably infiltrating the fiber, and then polymerizing the polymerizable composition, optionally at elevated temperature, preferably at 140 to 160° C.
2) By applying a vacuum to the pressure-tight mold with an otherwise identical setup to that in 1, and sucking in the polymerizable composition of the invention.
3) Transferring the polymerizable composition into the mold by a combination of reduced pressure and elevated pressure as under 1 and 2.
4) In that the production takes place in an extruder, the input streams of which contain fibers, especially short fibers, and the polymerizable composition, wherein the extruder is operated at a temperature above the melting temperature of the polymer that results from the polymerizable composition.
5) In that the production takes place in an extruder, the input streams of which contain one or more individual components of the polymerizable composition of the invention in solid or liquid form and fibers.
6) In that the production takes place by a conventional centrifugal casting method, wherein the polymerizable composition of the invention or the individual components a), b) and c) thereof are introduced in solid or liquid form and reinforced with fibers, preferably in the form of short fibers or in the form of textile reinforcing structures.
7) In that the production is effected continuously by impregnation of fibers, especially of weaves, which is polymerized after application of the polymerizable composition of the invention in liquid form at a temperature of 120 to 200° C., which gives rise to composite sheets, organosheets, profiles or tubes of continuously reinforced polyamides.

Preference is given to alternative 1, 2 or 3, with insertion of fibers, especially textile reinforcing structures, into a heatable, pressure-tight mold. Subsequently, the polymerizable composition is injected into the mold by means of elevated pressure of 1 to 150 bar and/or at a reduced pressure in the mold of 10 to 900 mbar.

On completion of filling of the mold with the polymerizable composition of the invention, polymerization is effected at the abovementioned temperatures. The composite component is formed directly in the mold.

Likewise preferred is the above procedure wherein, in a modification of the pressure-tight mold, a reduced pressure is applied, preferably of 5 to 800 mbar, and the polymerizable composition is sucked into the mold and, after the mold has been filled with the polymerizable composition, polymerized at the abovementioned temperature.

It is also advantageous that the polymerization is executed in a conventional centrifugal casting method, wherein the polymerizable composition is introduced into the mold in solid or liquid form and the fibers are introduced in the form of short fibers or in the form of textile reinforcements detailed above.

In the production of the polymerizable composition of the invention, as also in the inventive production of the fiber-reinforced composite materials, it may be advantageous to keep the proportion of components not involved in the production of the polymerizable composition or of the fiber-reinforced composite material as low as possible. These especially include water, carbon dioxide and/or oxygen. In a specific execution, therefore, the components and apparatuses used are essentially free of water, carbon dioxide and/or oxygen. One option is that the closed mold cavity used is put under reduced pressure before the melt is injected. A further additional option is the use of inert gas, for example nitrogen or argon. The polymerizable composition used, and also the fillers or reinforcers (fibers, such as textile fabrics), may be stored in or blanketed with an inert gas atmosphere.

Fibers

Preferably, fibers used in the process of the invention are short fibers, long fibers, continuous fibers or mixtures thereof.

In the context of the invention, “short fibers” have a length of 0.1 to 1 mm, “long fibers” a length of 1 to 50 mm, and “continuous fibers” a length of greater than 50 mm. Continuous fibers are used for production of the fiber-reinforced composites, preferably in the form of a textile structure, for example of weaves, loop-formed knits, loop-drawn knits, scrims or nonwovens. Components having extended continuous fibers generally achieve very high stiffness and strength values.

For encapsulation processes, in general, preference is given to the use of short fibers.

For production of two-dimensional composite sheets by the RIM method, the fiber material used is generally one composed of continuous yarns or continuous rovings arranged in parallel, which have been processed further to give textile fabrics such as scrims, tapes, braids and weaves and the like.

The aforementioned textile fiber structures may be single-ply or multi-ply and may be used for component production in different combination with regard to textile fabric, fiber types and the fiber volumes thereof. Preference is given to using scrims, multiaxial scrims, (multiaxial) braids or weaves that consist of two or more than two, preferably 2 to 9, plies.

The fiber materials used contain, as fibers, preferably those composed of inorganic minerals such as carbon, for example in the form of low-modulus carbon fibers or high-modulus carbon fibers, a wide variety of different types of silicatic and non-silicatic glasses, boron, silicon carbide, metals, metal alloys, metal oxides, metal nitrides, metal carbides and silicates, and organic materials such as natural and synthetic polymers, for example polyacrylonitriles, polyesters, polyamides, polyimides, aramids, liquid crystal polymers, polyphenylene sulfides, polyether ketones, polyetherether ketones, polyether imides, cotton, cellulose and other natural fibers, for example flax, sisal, kenaf, hemp, abaca. Preference is given to high-melting materials, for example glasses, carbon, aramids, liquid-crystal polymers, polyphenylene sulfides, polyether ketones, polyetherether ketones and polyether imides, particular preference being given to glass fibers, carbon fibers, aramid fibers, steel fibers, ceramic fibers and/or other sufficiently thermally stable polymeric fibers or filaments that do not dissolve in the hot activated melt.

Fibers may be used in an amount in the range from 5% to 65% by volume, based on the resulting fiber composite, corresponding, for example, to 10-80% by weight in the case of use of glass fibers, but preferably in an amount in the range from 45% to 65% by weight, based on the fiber composite, particularly preferred fibers being glass fibers or carbon fibers.

The process of the invention enables, in conjunction with the reinforcing fibers, in the polymerization, very low volume shrinkage, low residual monomer contents of the lactams involved, good impregnation of the reinforcing fibers, economically acceptable polymerization times and the formation of products having good mechanical properties.

The invention also relates to the use of the polymerizable composition of the invention for encapsulation operations, especially for fixing and/or for mechanical protection of cable bundles or for encapsulation of parts of electric motors, especially including current-conducting components.

Preference is given to the above use if the polymerizable composition is used in the presence of fibers for production of a fiber composite.

### EXAMPLES

The total mass of caprolactam and laurolactam specified in table 1 is divided into two masses of equal size in order to independently prepare the activator melt and the catalyst melt:

Catalyst Melt:

180 g of a mixture of caprolactam and laurolactam specified in table 1 and 20 g of Addonyl Kat NL (18.5% by weight sodium caprolactamate in caprolactam, CAS No. 2123-24-2), which is purchased commercially from Rhein Chemie Rheinau GmbH, are initially charged in a three-neck flask.

Activator Melt:

180 g of a mixture of caprolactam and laurolactam specified in table 1 are initially charged in a second three-neck flask together with 8.0 g of Addonyl 8120. Addonyl 8120 is a double-sidedly caprolactam-blocked hexamethylene diisocyanate, specifically N,N′-hexane-1,6-diylbis(hexahydro-2-oxo-1H-azepine-1-carboxamide), CAS No.: 5888-87-9.

The contents of the two flasks were melted in oil baths preheated to 150° C., then equilibrated to 110° C. This was followed by evacuation at this temperature for 10 minutes. Then the two flasks were filled with nitrogen and the oil baths were removed.

For polymerization of the activated melts, the two melts were introduced into an open, nitrogen-blanketed beaker and the melts were mixed with a glass stirrer bar; the beaker was heated with the aid of an oil bath heated to 160° C.

TABLE 1
Polymerization recipes used, densities achieved therewith both of the activated melts and
of the resulting polymers. Additionally listed are the residual monomer contents of caprolactam
and laurolactam. The polymer density was determined in accordance with DIN EN ISO 1183,
the residual monomer contents (RMC) via GC in accordance with DIN EN ISO 11337:

| | | | Density of the | Polymer | Polymer | RMG | RMG |
|---|---|---|---|---|---|---|---|
| | Capro- | Lauro- | partly activated* | density | density | Capro- | Lauro- |
| | lactam/ | lactam/ | melt at 150° C./ | at 23° C./ | at 150° C./ | lactam | lactam |
| | g | g | g · ml⁻¹ | g · ml⁻¹ | g · ml⁻¹ | % by wt. | % by wt. |
| CME A | 360 | / | 0.971 | 1.143 | 1.071 | 1.0 | 0 |
| INV 1 | 320 | 40 | 0.963 | 1.109 | 1.037 | 1.0 | 0 |
| INV 2 | 280 | 80 | 0.960 | 1.084 | 1.026 | 1.8 | 0.4 |
| INV 3 | 240 | 120 | 0.954 | 1.066 | 1.002 | 2.2 | 0.3 |
| INV 4 | 200 | 160 | 0.945 | X | X | X | X |
| CME B | 160 | 200 | / | X | X | X | X |
| CME C | 120 | 240 | / | X | X | X | X |
| CME D | 80 | 280 | / | X | X | X | X |
| CME E | 40 | 320 | / | X | X | X | X |
| CME F | / | 360 | / | X | X | X | X |

CME: comparative example; INV: inventive;
X: polymerization starts immediately after the mixing of catalyst melt and activator melt; therefore, the combined melts cannot be transferred into the vessel intended for full polymerization

TABLE 2
Calculated volume shrinkage (shrinkage) from the density values

| | Shrinkage | Shrinkage |
|---|---|---|
| | A/% | B/% |
| CME A | 15.0 | 9.3 |
| INV 1 | 13.2 | 7.1 |
| INV 2 | 11.4 | 6.4 |
| INV 3 | 10.5 | 4.8 |

Shrinkage A: change in density and hence in volume of the activated lactam melt melted at 150° C. in relation to the polymer formed at 23° C.
volume shrinkage in percent = (1 − density of the polymerizable lactam melt at 150° C./density of the polymer obtained at room temperature 23° C.) × 100
Shrinkage B: change in density and hence in volume of the activated lactam melt melted at 150° C. in relation to the polymer formed at likewise 150° C. (cooled to room temperature after preparation and heated to 150° C. again for density determination).
volume shrinkage in percent = (1 − density of the polymerizable lactam melt at 150° C./density of the polymer obtained at 150° C.) × 100

Conclusion:

Volume shrinkage in the conversion of the activated caprolactam melt to the polymer at 150° C. was distinctly reduced by the presence of up to about 30% by weight of laurolactam. Higher laurolactam contents (over and above 40% by weight) were no longer manageable by the procedure described.

1. A polymerizable composition comprising:
a) cyclic amides comprising at least a mixture of laurolactam and caprolactam, where the amount of laurolactem is 10% to 35% by weight, based on the total amount of cyclic amides,
b) at least one activator, and
c) at least one catalyst for polymerization of the cyclic amides.

2. The polymerizable composition as claimed in claim 1, wherein the activator comprises at least one compound selected from the group consisting of isocyanates, uretdiones, carbodlimides, add anhydrides, add halides or the reaction products thereof with the monomer.

3. The polymerizable composition as claimed in claim 1, wherein the activator comprises at least one blocked isocyanate.

4. The polymerizable composition as claimed in claim 1, wherein the at least one catalyst comprises a catalyst selected from the group consisting of sodium caprolactamate, potassium caprolactamate, magnesium bromide caproiactamate, magnesium chloride caprolactamate, magnesium bis(caprolactamate), sodium hydride, sodium, sodium hydroxide, sodium methoxide, sodium ethoxide, sodium propoxide, sodium butoxide, potassium hydride, potassium hydroxide, potassium methoxide, potassium ethoxide, potassium propoxide and potassium butoxide.

5. The polymerizable composition as claimed in claim 1, wherein the catalyst comprises sodium caprolactamate.

6. A process for preparing a polymerizable composition as claimed in claim 1, the process comprising contacting the cyclic amides with the activator and the at least one catalyst.

7. The process as claimed in claim 6, wherein the process comprises:
producing.an activator mixture comprising cyclic amides of component a) and at least one activator of component b);
producing a catalyst mixture comprising cyclic amides of component a) and at least one catalyst of component c); and
combining the activator mixture and the catalyst mixture.

8. A process for producing a polymer matrix, the process comprising treating the polymerizable composition as claimed in claim 1 at a temperature of 120 to 200° C.

9. A process for producing a fiber composite, the process comprising:
i) contacting the polymerizable composition as claimed in claim 1 or the individual components a), b) and c) with fibers to form a resulting composition; and
ii) treating the resulting composition at a temperature of 120 to 200° C.

10. A polymer matrix obtained by the process as claimed in claim 8.

11. A method for encapsulation of a component, the method comprising at least one of:
forming a capsule of the polymerizable composition as claimed in claim 1 with a cavity therein for receipt of the cornponent; and
encapsulating the component with the polymerizable composition, and polymerizing the polymerizable composition.

12. The method as claimed in claim 11, wherein:
the component is a cable, cable bundle, or component of an electric motor; and
the method further comprises adding fibers to the polymerizahie composition to produce a fibrous encapsulation composite for encapsulating the component.

13. A fiber composite obtained by the process as claimed in claim 9.

14. The polymerizable composition as claimed in claim 1, wherein:
the activator comprises a diisocyanate blocked with a cyclic amide, and
the cyclic amides comprise more than 95% by weight of combined laurolactam and caprolactam; and
the polymerizable composition contains 60% to 100% by weight of components a) to c).

15. The polymerizable composition as claimed in claim 1, wherein the activator comprises caprolactam-blocked hexamethylene diisocyanate.

16. The polymerizable composition as claimed in claim 1, wherein the catalyst comprises a catalyst selected from the group consisting of sodium hydride, sodium and sodium caprolactamate.

17. The polymerizable composition as claimed in claim 1, wherein the catalyst comprises sodium caprolactamate.

18. The polymerizable composition as claimed in claim 1, wherein:
the cyclic amides comprise more than 98% by weight of combined laurolactam and caprolactam;
the activator comprises caprolactam-biocked hexamethylene diisocyanate;
the catalyst comprises sodium caprolactamate; and
a mass ratio of the cyclic amides to the blocked isocyanate is 20:1 to 1000:1; and
a molar ratio of the cyclic amides to catalyst is 1:1 to 500:1; and
the polymenzable composition contains 95% to 100% by weight of components a) to c) based on the total weight of the composition.

19. The polymerizable composition as claimed in claim 1, wherein:
the cyclic amides comprise more than 98% by weight of combined laurolactam and caprolactam;
the activator comprises caprolactam blocked hexamethylene diisocyanate;
the catalyst comprises sodium caprolactamate; and
a mass ratio of the cyclic amides to the blocked isocyanate is 20:1 to 1000:1; and
a molar ratio of the cyclic amides to catalyst is 1:1 to 500:1; and
the polymerizable composition contains up to 50% by weight of fillers selected from kaolin, chalk, wollastonite, talc, calcium carbonate, silicates, titanium dioxide, zinc oxide, graphite, graphenes, glass particles, nanoscale fillers carbon black, nanoscale sheet silicates, nanoscale aluminum oxide (Al₂O₂), nanoscale titanium dioxide (TiO₂), boron fibers, glass fibers, carbon fibers, silica fibers, ceramic fibers, basalt fibers; aramid fibers, polyester fibers, nylon fibers, polyethylene fibers; wood fibers, flax fibers, hemp fibers, and sisal fibers.
